(19) United States
(12) Patent Application Publication
(10) Pub. No.: US 2015/0128545 A1
(43) Pub. Date: May 14, 2015

(54) METHOD FOR PRODUCING A NONWOVEN FABRIC

(71) Applicant: IREMA FILTER GmbH, Postbauer-Pavelsbach (DE)

(72) Inventor: Andreas Seeberger, Nuremberg (DE)

(73) Assignee: IREMA FILTER GmbH, Postbauer-Pavelsbach (DE)

(21) Appl. No.: 14/405,258

(22) PCT Filed: Dec. 2, 2013
(86) PCT No.: PCT/EP2013/001634

§ 371 Date: Dec. 3, 2014

(30) Foreign Application Priority Data
Jun. 4, 2012 (DE) 10 2012 011 065.0

(51) Int. Cl. B01D 39/16; B01D 67/00; B01D 46/52

(52) U.S. Cl. CPC B01D 39/1623; B01D 46/521; B01D 67/0002
USPC 55/490; 264/103; 425/380

(57) ABSTRACT

The invention relates to a method for producing a nonwoven fabric (1), in particular a filter medium or air filler medium consisting of a nonwoven, in a melt-spinning method comprising the following steps: Melting a raw material, spraying the raw material from at least one spinning die (6) and capturing the raw material on a support layer (12) such that the nonwoven fabric (1) is formed. The support layer (12) has structures, so that spacers (2) are formed in the nonwoven fabric (1).

The invention relates to a method for producing a nonwoven fabric, particularly a nonwoven filter medium or air filter medium, in a melt-spinning process comprising the steps: melting a polymer, spraying the polymer out of at least one spin beam and collecting the polymer on a substrate so as to form a nonwoven fabric.

Nonwoven fabrics produced with this method are used as filter media in filters, e.g. in air filters and air conditioning systems, particularly however in air filters for motor vehicle interiors or engines.

Nonwoven fabrics are usually produced in a primary forming method using a melt-spinning process such as, for example, a spun-bond or a melt-blown process as described e.g. in DE 41 23 122 A1.

The intake air of internal combustion engines, for example in motor vehicles or in off-road applications, is normally filtered to protect the engine's combustion chamber from mechanical damage due to particles sucked in from the ambient air. An important design criterion for filter elements is ensuring long filter service life along with concurrently high effective filtration of ingested particles.

Then again, however, motor vehicles have a precisely calculated energy distribution system. Only limited amounts of energy are provided for heating/ventilation/cooling. Due to ever stricter exhaust regulations, these energy quantities continually need to be markedly reduced, particularly also in the case of electric vehicles in which, to the greatest extent possible, mechanical energy is only to be expended for drive propulsion. There are also narrow limits governing the costs of vehicle components. On the other hand, vehicle buyers are continually demanding greater comfort and safety. From these perspectives, particle filters having the lowest possible loss or difference in pressure are of special significance as the fan motor only needs to generate lower pressure, with energy consumption consequently being less. Moreover, due to the lesser amount of power required, they also run more quietly which reduces noise and thus considerably increases driving comfort.

The demand for filter systems having low pressure differentials competes with the required filtration efficiency and the required service life; i.e. the amount of time expressed in mileage which a filter can remain in the vehicle before needing to be replaced.

For example, pollen filters which only filter pollen out of the air flowing into the vehicle are not enough for vehicle interiors. The allergens which cause the immune system of allergy sufferers to react are proteins having diameters of only a fraction of the diameter of pollen. They are in the 0.1 μm size range; i.e. the range which is most problematic for particle filters, the so-called MPPS (Most Penetrating Particle Size). Correspondingly, the filtration efficiency at this size should be at least 50%, whereby this is measured by means of an aerosol having particles of roughly the same density, e.g. NaCl. At the same time, the service life of such filters installed into motor vehicles should be at least 30,000 kilometers.

In common filters, e.g. ring filters or frame filters, the filter material has a zigzag folding; i.e. pleating. The use of spacers is known in order to prevent adjacent filter surfaces in such a pleating from falling on each other and thereby reducing the surface exposed to the flow. Such spacers are usually obtained by texturing the filter material. However, satisfactory texturing is only possible in the case of paper filters. In contrast, PP, PET or polyester filters texture very poorly, if at all.

In the case of nonwoven fabric filters made from these materials consisting of nonwoven fibers, it is thus known to either utilize the substrate of the filter material as spacers or, in the case of filters without substrates, to create spacers by appropriately melting the filter material. However, all of these alternatives reduce the surface of the filter exposed to the airflow, same being defined by the filter material surface which is pervious to the flow of air to be filtered. This thus increases the pressure differential. Furthermore, an additional procedural step is required to provide a substrate or for the melting or texturing. In the case of the substrate, this incurs even further material costs which raises the cost of the filter.

EP 1 970 111 A1 discloses a composite filter media structure having a corrugated base substrate of nonwoven synthetic fibers produced in a dry-laid process and in which the base substrate is corrugated during the forming process. To corrugate the nonwoven synthetic fibers, the fibers are heated and guided through opposingly profiled calender rolls. In a finished filter element, adjacent folds of the corrugation form oval tubes which allow filtered air to flow through the filter element.

The objective of the present invention is providing a method for producing a nonwoven fabric which overcomes the above disadvantages and by means of which a nonwoven fabric is produced without any additional procedural steps being required to incorporate spacers beyond the primary forming process of the nonwoven fabric. A further objective is providing a corresponding production unit as well as the nonwoven fabric itself.

This objective is accomplished by the method according to claim 1, an apparatus for producing a nonwoven fabric according to claim 8, a nonwoven fabric according to claim 11 and a filter according to claim 16. According to the invention, a raw material which will form the eventual nonwoven fabric collects on a substrate exhibiting a structure such that spacers will form in the nonwoven fabric during the formation of the nonwoven fabric.

The inventive method for producing a nonwoven fabric has the advantage of introducing spacers into the nonwoven fabric right during the primary forming process itself; i.e. during the applicable melt-spinning process. This allows a procedural step to be omitted since the filter material does not have to be textured nor corrugated nor melted in order to ensure distance between the adjacent layers of the nonwoven fabric, e.g. in a pleating.

Nor do projections and/or depressions serving as spacers need to be incorporated over the entire surface of the nonwoven fabric, as is for example necessary when corrugating. Only by so doing is it possible to provide a filter with substantially flat adjacent layers kept at a defined distance from one another.

The spacers can be varied as needed by the design to the substrate utilized in the primary forming process. The size and/or density of the spacers can thus be kept low for the respective application. This ensures that spacers cover the smallest possible part of the nonwoven fabric surface, which in turn improves the filtering properties of such a nonwoven fabric as filter material.

A nonwoven fabric in accordance with the present invention is a textile fabric of individual fibers substantially consisting of loose, closely arranged, non-coalesced fibers. Raw materials for the nonwoven fabric are preferably mineral fibers, for example glass, asbestos, mineral wool, basalt, chemical fibers, e.g. from natural polymers such as cellulose or from synthetic polymers such as polyamide, polyester, polyvinyl chloride, polypropylene, polyethylene, polyphenylene sulfide, polyacrylonitrile, polyimide, polytetrafluorethylene, aramide, polyamide or also fiber blends of at least two of these raw materials.

A melt-spinning process in accordance with the present invention is any type of melt-blown process which can be used to produce a nonwoven fabric.

A spin beam in accordance with the present invention is any type of apparatus which can be used to spray polymer. In particular, a spin beam relates to one or more spray nozzles arranged predominantly adjacently, particularly in a beam.

A substrate in the sense of the invention is a surface which lends itself to collecting a sprayed raw material. In the process, the substrate generally moves relative to a spin beam.

A structure in the sense of the invention is any type of three-dimensional structure formed on the two-dimensional substrate, or also a hole.

A spacer in the sense of the invention is any type of formation and/or material change to a nonwoven fabric which serves to keep two layers of at least one nonwoven fabric apart from each other when they are laid flat upon each other.

In one advantageous embodiment of the invention the structures are arranged in a defined manner such that substantially flat layers of the nonwoven fabric can be kept apart from each other at a defined distance by the formed spacers, particularly by spacers of adjacent folds of a pleating meeting and/or not meeting in the pleating depending on their definition.

A flat layer in the sense of the invention is thereby a continuous surface.

This arrangement of spacers makes the nonwoven fabric particularly well-suited as an air filter medium for the production of an air filter. The spacers hereby permit the medium to be filtered the most unobstructed flow possible along the layers of a filter medium. The spacers further prevent individual layers of a filter from collapsing on each other.

In a further advantageous embodiment, the spacers are formed on the flat layers of the nonwoven fabric.

In a further advantageous embodiment of the invention, the raw material is guided between the spin beams and the substrate by a flow of air and/or the air is suctioned out under the substrate.

Both measures serve to capture and/or deposit the raw material on the substrate as well as control the turbulence of the raw material prior to it striking the substrate.

In a further advantageous embodiment of the invention, the raw material is deep-drawn into the structures of the substrate by the flow of air and/or by the force of gravity.

The deep drawing of the raw material has the advantage that spacers can be disposed on more than just one side of the filter medium.

In a further advantageous embodiment, different types of raw material are sprayed from two different spin beams.

This allows varying the material properties of the nonwoven fabric according to the polymer blends employed.

In a further advantageous embodiment of the invention, the at least one spin beam can pulsate the raw material flow rate and/or pressure over time.

The pulsation and thereby associated change in the spraying of the raw material out of the spin beam(s) effects a change in the structure of the nonwoven fabric.

In a further advantageous embodiment of the invention, the substrate is coated, particularly Teflon-coated. The coating enables the nonwoven fabric to be removed from the substrate without any difficulty despite the structures on said substrate.

In a further advantageous embodiment, the structures are respectively arranged such that the spacers of adjacent folds of the pleating meet or do not meet in the nonwoven fabric pleating.

Depending on application; i.e. stability and pleat spacing requirements, it can be advantageous for the spacers to be arranged at a respective offset or be arranged so as to meet when pleated. Doing so enables the spacing of individual layers and the stability thereof to be regulated.

The above advantages and definitions apply to the apparatus for producing a nonwoven fabric and the inventive nonwoven fabric analogously.

The inventive nonwoven fabric has the further advantage of substantially the same material structure over the entire nonwoven fabric surface despite the presence of the spacers.

The material is not compacted by the structuring or even by a melting of the material when creating spacers. Thus, heating and/or also corrugating does not damage the open-pored structure of the fibers. Nor is there the need for continuous processing of the material as is generally necessary when corrugating. Additionally, spacers can be provided even when the rest of the nonwoven fabric remains in a substantially planar form. The spacers can furthermore also be arranged in non-symmetrical or irregularly repeated sequences.

In a further advantageous embodiment of the invention, the nonwoven fabric is a single layer.

Single layer in the sense of the invention means that it is not possible to distinguish two different layers in the nonwoven fabric, the material is instead of continuous configuration, wherein the respective material structure transitions, e.g. in the density of specific fibers, are continuous.

In a further advantageous embodiment of the invention, the filtering effect of the nonwoven fabric remains substantially constant over its entire surface.

The nonwoven fabric thereby forms a preferably cohesive surface which preferably does not exceed and, particularly preferentially, does not fall short of a specific pore size.

In a further advantageous embodiment of the invention, the nonwoven fabric can be pleated in self-supporting manner.

Incorporating the spacers three-dimensionally reinforces the nonwoven fabric such that it can be pleated in self-supporting manner without a further substrate layer or additional reinforcement and without producing any substantial warpage.

In a further advantageous embodiment of the invention, the height of the spacers is contingent upon the position of the respective spacer in a substantially flat layer of the pleated nonwoven fabric.

The spacing of the pleated nonwoven fabric layers can thereby be controlled by the respective spacer heights such that different spacings can be defined at different locations between two layers.

In a further advantageous embodiment of the invention, height increases from a first pleat to a second pleat. In a further advantageous embodiment of the invention, the height to a third pleat decreases again.

This design achieves uniform pleating having well-defined individual pleat opening angles.

The above as well as further advantages, features and possible applications of the present invention follow from the description of preferred embodiments below in reference to the drawings, which show the following:

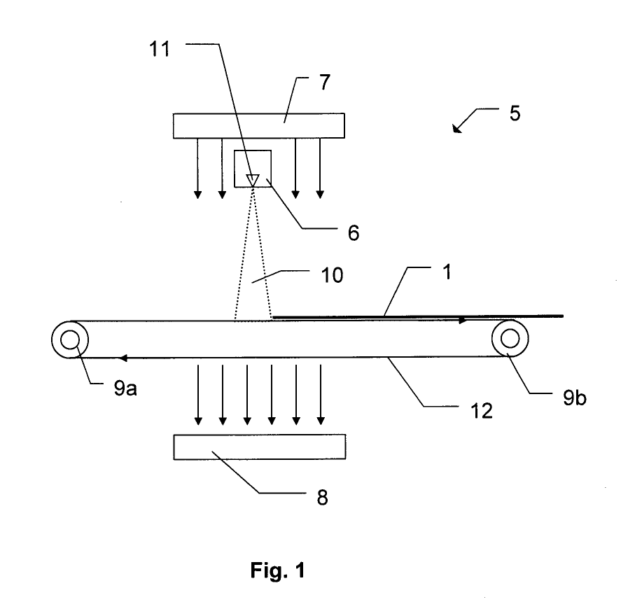

FIG. 1 is a schematic representation of an apparatus for producing a nonwoven fabric according to the invention;

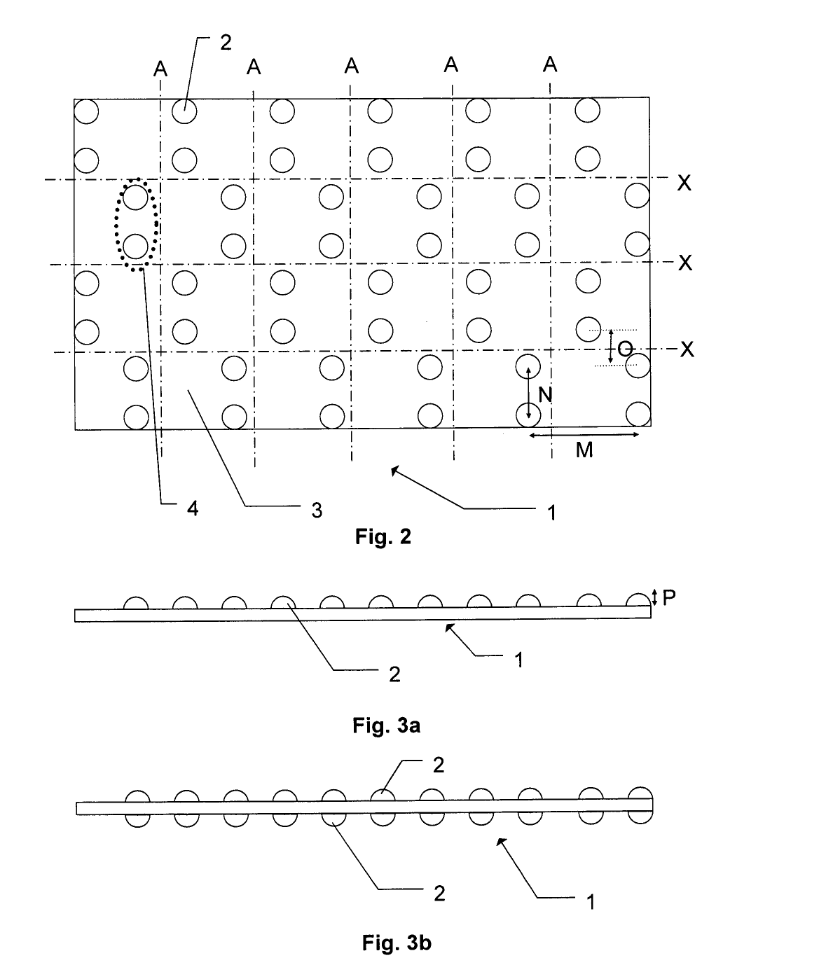

FIG. 2 is a schematic top plan view of a nonwoven fabric according to a first and second embodiment of the invention;

FIG. 3a is a schematic side view of the nonwoven fabric as per FIG. 2 according to the first embodiment of the invention;

FIG. 3b is a schematic side view of a nonwoven fabric as per FIG. 2 according to the second embodiment of the invention;

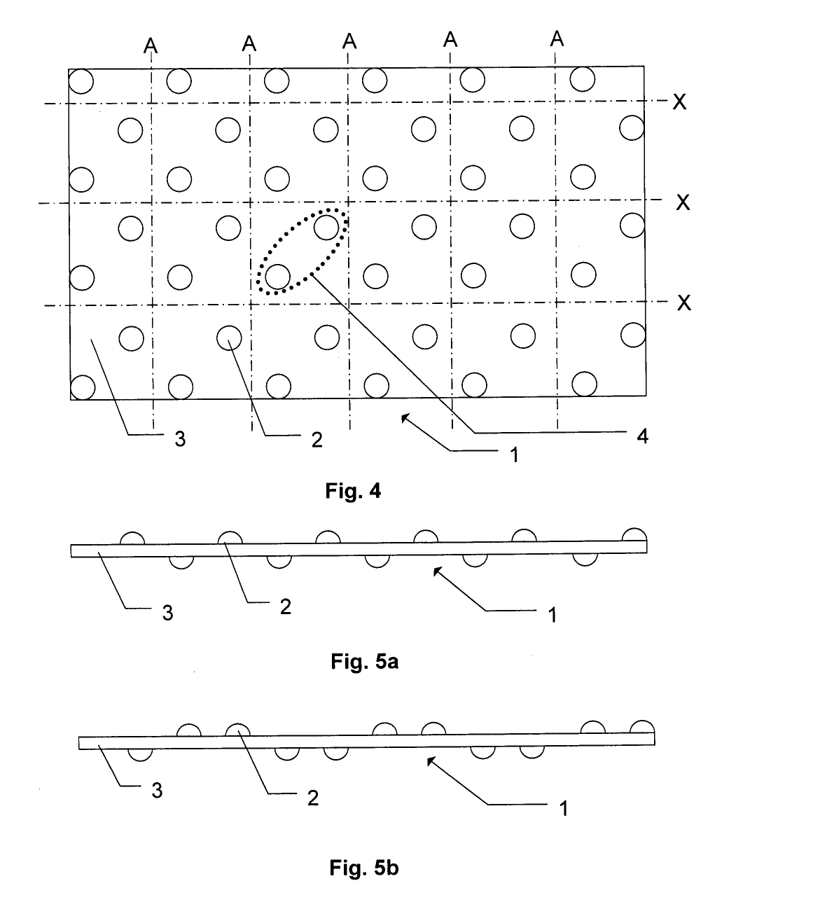

FIG. 4 is a schematic top plan view of a nonwoven fabric according to a third or fourth embodiment of the invention;

FIG. 5a is a schematic side view of an inventive nonwoven fabric as per FIG. 4 according to the third embodiment of the invention;

FIG. 5b is a schematic side view of the inventive nonwoven fabric as per FIG. 4 according to the fourth embodiment of the invention;

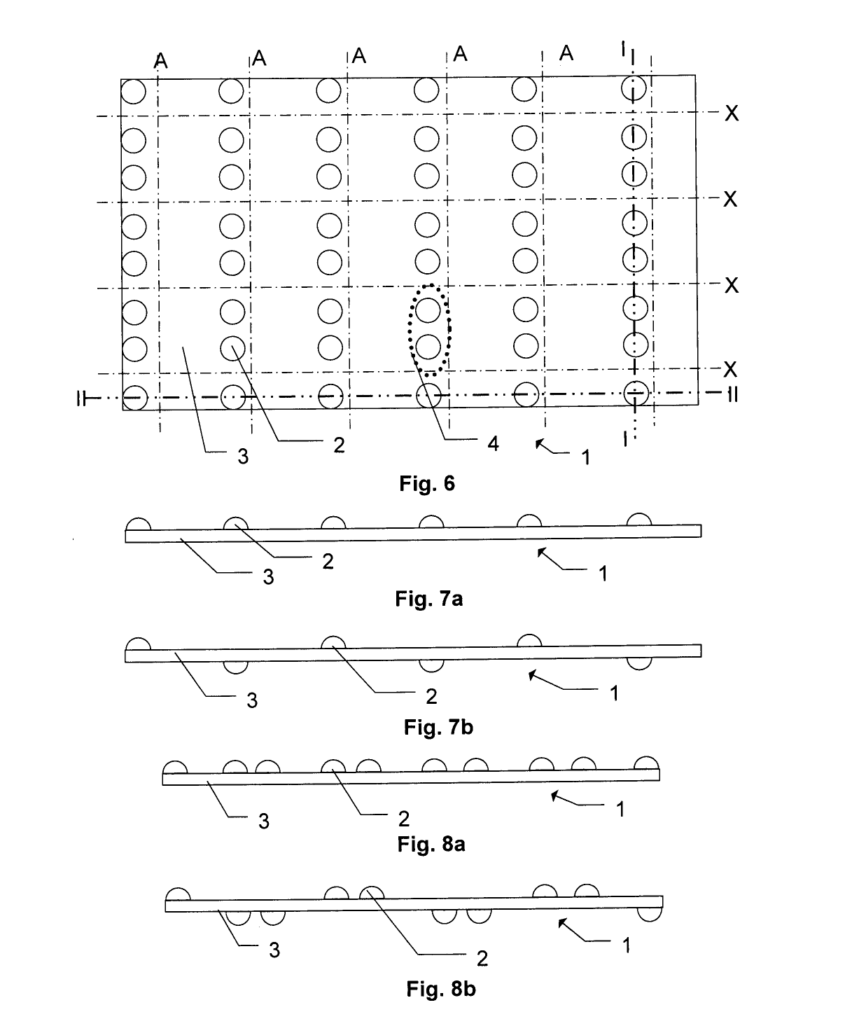

FIG. 6 is a schematic top plan view of a nonwoven fabric according to a fifth to eighth embodiment of the present invention;

FIG. 7a is a schematic side view toward pleat A of the inventive nonwoven fabric as per FIG. 6 according to the fifth embodiment;

FIG. 7b is a schematic side view toward pleat A of the inventive nonwoven fabric as per FIG. 6 according to the sixth embodiment;

FIG. 8a is a schematic side view toward pleat X of the inventive nonwoven fabric as per FIG. 6 according to the seventh embodiment;

FIG. 8b is a schematic side view toward pleat X of an inventive nonwoven fabric as per FIG. 6 according to an eighth embodiment;

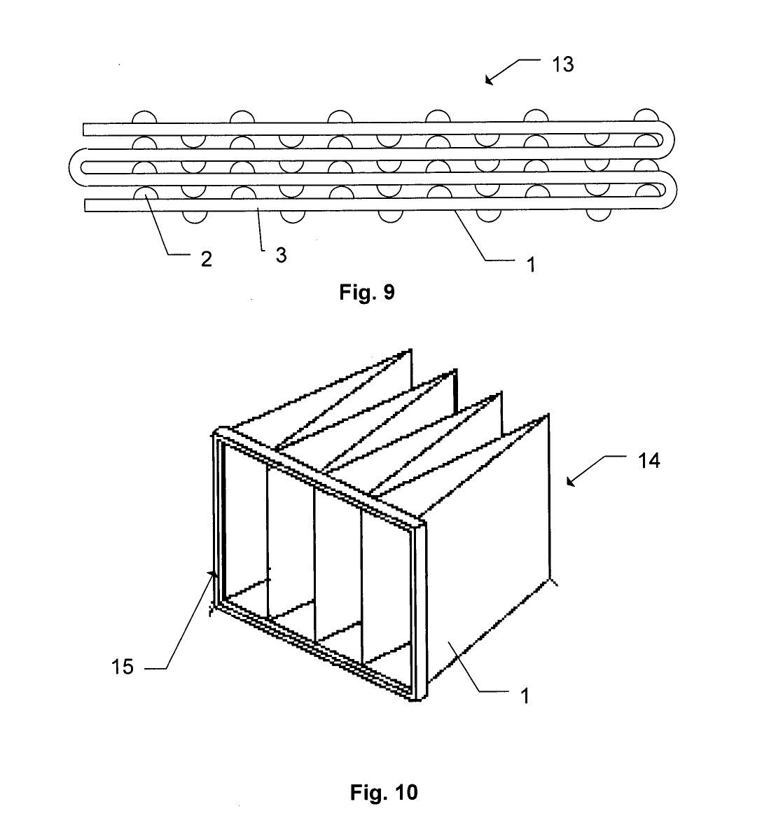

FIG. 9 is a schematic representation of a pleated inventive nonwoven fabric in accordance with the third embodiment of the invention as per FIGS. 4 and 5a;

FIG. 10 is a schematic representation of a filter having an inventive nonwoven fabric as a filter medium.

Reference will be made to FIG. 1 in detailing a preferred apparatus for producing a nonwoven fabric and a preferred method of producing same. The apparatus according to the invention preferably comprises a spin beam 6 on or in which at least one spray nozzle 11 is preferably arranged. The spin beam 6, or spray nozzle 11 respectively, is fed a pressurized liquid raw material, preferably a polymer, which sprays out of nozzle 11. This sprayed raw material forms a jet 10 which deposits or collects on the substrate 12. Preferably, the jet 10 is hereby directed by the spraying orientation of the spray nozzle 11 and the force of gravity G. Particularly preferentially, the direction and/or turbulence of the polymer jet 10 is controlled by a fan 7 and/or an exhaust 8. The fan 7 and/or exhaust 8 can produce a flow of air, indicated by arrows in FIG. 1. Depending on the intensity, turbulence and direction of the airflow, the structure of the nonwoven fabric 1 formed on the substrate 12 can thereby be influenced.

The substrate 12 moves relative to the spin beam 6 while a jet spray 10 is sprayed from same, or from spray nozzle(s) 11 respectively. The velocity of the substrate 12 can thereby influence the size and/or thickness of the nonwoven fabric 1. Preferably, the substrate 12 is guided in a circle as a belt conveyor by two rollers 9a and 9b. At one end of the belt conveyor, which in the present case is formed by roller 9b, the nonwoven fabric 1 then passes on to the next process step and/or is deposited and/or rolled up as sheeting respectively.

The inventive method for producing a nonwoven fabric preferentially proceeds as follows: First, a raw material is melted. After that, it is introduced via lines into the spin beam 6 and to the spray nozzle(s) 11 which spray out the raw material, wherein same strikes the substrate 12 in a jet spray 10. Structures (not shown) are arranged on the substrate 12. The structures on the substrate 12 serve as negatives for the later spacers 2 in the nonwoven fabric 1. The raw material jet spray 10 collecting on the substrate 12 forms a nonwoven fabric 1 evenly covering the substrate 12. So doing also covers the structures of the substrate 12 which give the nonwoven fabric 1 a form comprising spacers 2 even upon just depositing on the substrate 12. The spacers 2 are thus formed during the primary forming process of the nonwoven fabric 1.

Thereafter, the nonwoven fabric 1 is removed from the area of the jet spray 10 by the movement of the substrate 12 and gradually cooled.

The structures on the substrate 12 are preferably projections and/or depressions. It is particularly preferential for the depressions to thereby be holes. The material can thereby be deep-drawn into the depression or holes by the force of gravity G and/or a flow of air produced by the fan 7 or the exhaust 8.

Preferably, the jet spray 10 is pulsated over time by the pulsating flow and/or the force of the polymer through the at least one spin beam 6. Size and/or thickness can thus be varied across the surface of the nonwoven fabric 1. Furthermore, the structure of the individual fibers of the nonwoven fabric 1 can preferably be altered.

The structures of the substrate 12 are preferentially round, oval or polygonal in plan view.

Particularly preferentially, however, they can also be grooves and/or channels arranged either transverse or longitudinal to the substrate's direction of movement, said grooves and/or channels can preferably also be non-continuous. The structures are preferentially configured as segments of polygons, spheres, cones or a three-dimensional oval body.

The arrangement of the structures is thereby preferably such that spacers 2 of adjacent folds of a pleating either meet or do not meet depending on the desired spacing and stability to the individual layers of the produced nonwoven fabric 1.

The structures preferably exhibit a height of from 0.1 to 2 cm, preferentially 0.2 to 1 cm, particularly preferentially 0.3 to 0.8 cm, particularly preferentially 0.4 to 0.6 cm, and most preferentially 0.5 cm. However, the effect of the invention is not limited to these height values and also encompasses peripheral ranges outside of the indicated ranges.

The substrate 12 is preferably made from metal, glass or polymer. Glass-fiber reinforced plastic is hereby particularly preferential. Furthermore, the substrate 12 is preferably coated, particularly Teflon-coated. The substrate 12 can thereby be designed as a screen, grate, wire mesh or a smooth surface.

In a further embodiment of the apparatus for producing a nonwoven fabric 1, the apparatus comprises a plurality of spin beams 6. The jet sprays 10 sprayed from the different spin beams 6 can thereby be sprayed parallel or overlapping each other. Preferably, the jet sprays 10 of neighboring spin beams 6 are thereby adjusted such that the respectively sprayed raw material is deposited one atop the other. The two layers of differing raw materials can then preferably be cured together in a further process step such as, for example, calendering or thermal treatment. In a further embodiment, the different spin beams spray either the same raw material or different raw materials at the same time. Mixing of the sprayed jet sprays 10 is hereby also induced by the airflows produced by the fan 7 or the exhaust 8 respectively. In one preferred embodiment, the airflow of fan 7 occurs directly at the outlet of the nozzle 11. With a plurality of spin beams 6, the flow rate and/or the pressure can be pulsated differently by respectively different spin beams 6.

FIG. 2 will be referenced in describing the first and second embodiment of the inventive nonwoven fabric 1 in greater detail. The nonwoven fabric 1 exhibits substantially flat components, respectively layers 3; i.e. surface components, and spacers 2 which rise above the flat components 3 in one and/or another direction. In the embodiment of the inventive nonwoven fabric 1 depicted here, the spacers as depicted are preferably circular; i.e. round. Oval or polygonal spacers are particularly preferable. It is highly preferential for them to be configured as grooves or channels, preferably extending toward pleats A or toward pleats X. Preferably, the spacers are thereby projections and/or depressions. Arranging the spacers 2 in a certain symmetry as in the embodiment depicted here increases the rigidity between the pleats A, X which makes the nonwoven fabric 1 particularly easy to fold, particularly preferentially pleatable in self-supporting manner.

Two spacers 2 preferably form one respective spacer group 4. When the nonwoven fabric 1 is folded along pleats A or X, the respective groupings 4 of spacers of adjacent pleats do not lie atop each other. Depending on whether the spacers 2 of a grouping 4 rise from the planar area 3 in the same or opposite direction, they then form spacers 2 to the nearest pleat or to the two nearest pleats. The first variant is depicted in FIG. 3a, the second variant in FIG. 3b in the side view of the nonwoven fabric 1 according to FIG. 1. Respective spacers 2 of a grouping 4 oriented in respectively opposite directions form a nonwoven fabric 1, the spacing of which provides a particularly good control of the spacing of individual pleats when the nonwoven fabric is folded along pleats A or X.

The pleats A and X depicted in the figures only indicate the symmetry of the respective pleating direction. Folding preferably does not occur at each of these pleats A, X and any of the given depicted pleats A, X can be used as such.

Preferably, a nonwoven fabric 1 can also comprise a plurality of groupings 4 in one section between two respective pleats A, X.

Preferably, the nonwoven fabric 1 according to the invention is a single-layer nonwoven fabric 1. As defined by the invention, single layer hereby means that when the respective polymer fibers are deposited atop one another successively, it is not possible to distinguish two separate layers in the cross section of the nonwoven fabric, as is also shown in FIGS. 3a and 3b, as formed for example in two successive melt-spinning processes. The single-layer structuring to the nonwoven fabric 1 prevents the problem of individual layer delamination.

Achieved at the same time is that the nonwoven fabric 1 has a substantially uniform thickness and internal structure substantially over its entire surface, even in the region of the spacers 2. Despite the single-layer configuration, it is possible for the nonwoven fabric 1 to exhibit cross-sectional variations in its internal structure. By utilizing the melt-spinning process to produce the nonwoven in a single-stage primary forming process, however, such variations are continuous over the material. There are preferably no discrete structural changes as occurs in double-layer nonwoven fabric.

The nonwoven fabric 1 is preferably pleated along pleats A or X in order to be integrated into a frame or a round filter as filter material. The spacings of the individual pleats A, X, or their arrangement relative to the geometry of spacers 2 or groupings 4 respectively, are hereby freely selectable. In FIG. 2, essentially each symmetrical line of the nonwoven fabric 1 can be a possible pleat. The distances M, N and O between the spacers 2 and/or groupings 4 of spacers are essentially also freely selectable. Preferentially, distance O is smaller than distance N, which is in turn further preferentially smaller than distance M.

The height P of the spacers 2, their extension above the surface of the substantially flat component of the nonwoven fabric 3 respectively, is preferably 0.1 cm to 2.0 cm, preferentially 0.2 cm to 1.0 cm, particularly preferentially 0.3 cm to 0.8 cm, particularly preferentially 0.4 cm to 0.6 cm and most preferentially 0.5 cm. However, the effect of the invention is not limited to these values for height P and also encompasses peripheral ranges outside of the indicated ranges.

Preferably, the height P of the spacers 2 is a function of their position in the pleating so as to obtain a uniform pleating as depicted in FIG. 10. Preferably, the height P thereby increases perpendicularly from a first pleat A, X to a second pleat A, X. Further preferably, the height P in turn decreases again from the second pleat A, X to a third pleat A, X.

The height P of the spacers thereby corresponds substantially to the height of the structures (not shown) disposed on the substrate 12. The substrate 12 thereby substantially serves as a negative model (negative) of the nonwoven fabric subsequently formed thereon which constitutes the positive model (positive). The thickness of the nonwoven fabric 1 is substantially contingent upon the properties desired. When, as in FIG. 3b, spacers 2 are provided on both sides of the substantially flat component 3 of the nonwoven fabric 3, the height and/or extension of the spacers P, P′ can be equal or also have different values.

FIGS. 4, 5a and 5b are referenced in describing the third and fourth embodiment of the invention. The embodiments depicted in FIGS. 4, 5a and 5b essentially differ from the embodiments of FIGS. 2, 3a and 3b by the arrangement of the spacers 2 or their groupings 4 respectively. FIGS. 5a and 5b are both top plan views of a nonwoven fabric 1 according to FIG. 4 in the direction of pleats A/X. The two embodiments of FIGS. 5a and 5b essentially differ by the orientation to the respective spacers 2 arranged in a row in the direction of pleats A.

FIGS. 6, 7a, 7b, 8a and 8b are referenced in describing the fourth to eighth embodiment of the invention.

These embodiments are essentially identical to those of FIGS. 4, 5a and 5b, whereby the pleats A, X have a different arrangement. Furthermore, the distances M, N and O are freely selectable and preferably have values as described with reference to the embodiments of FIGS. 2, 3a and 3b. The embodiments of FIGS. 6, 7a, 7b, 8, 8a and 8b essentially differ from the embodiments of FIGS. 4, 5a and 5b by the orientation of the spacers 2. FIGS. 7a and 7b thereby reflect the orientation of the spacers 2 along the II-II line in FIG. 6, FIGS. 8a and 8b in each case the orientation of the spacers along the I-I line.

Preferentially, the individual embodiments can also be combined and any series of spacers can preferably be of that arrangement as is necessary in order to produce the desired spacing between individual layers of a nonwoven fabric 1.

FIG. 9 depicts a pleated nonwoven fabric 1 according to the third embodiment of the invention as per FIGS. 4 and 5a. It is clearly recognizable that the spacers 2 keep the individual layers of the surface component 3 of the nonwoven fabric 1 at a defined spacing.

FIG. 10 depicts a preferential filter comprising a nonwoven fabric according to the invention as the filter medium. The depicted filter exhibits a pleated nonwoven fabric 1 as well as a frame 15 with which the filter can be installed at its point of use.

### LIST OF REFERENCE NUMERALS

1 nonwoven fabric
2 spacer
3 surface component
4 grouping
5 apparatus for producing a nonwoven fabric
6 spin beam
7 fan
8 exhaust
9a, 9b first, second guide roller
10 jet spray
11 spray nozzle
12 substrate
13 pleated nonwoven fabric/filter medium
14 filter
15 filter frame
A, X pleat
P spacer height
M, N, O distance between spacers

1. A method for producing a nonwoven fabric (1), particularly a nonwoven filter medium or air filter medium, in a melt-spinning process comprising the following steps:
melting a raw material;
spraying the raw material out of at least one spin beam (6);
collecting the raw material on a substrate (12) so as to form the nonwoven fabric (1);
wherein the substrate (12) comprises structures such that spacers (2) form in the nonwoven fabric (1).

2-9. (canceled)

10. An apparatus (5) for producing a nonwoven fabric, particularly a filter medium or air filter medium, comprising:
at least one spin beam (6);
a substrate (12) which is preferably movable substantially perpendicular to the spin beam (6), wherein the substrate (12) comprises structures arranged in a manner such that a nonwoven fabric (1) with spacers (2) can be formed on the substrate (12) such that the spacers (2) can keep substantially flat layers in the nonwoven fabric (1) at a defined distance from one another.

11. (canceled)

12. The apparatus according to claim 10, wherein the structures are arranged in a defined manner such that substantially flat layers of the nonwoven fabric (1) can be kept apart from each other at a defined distance by the formed spacers (2), particularly by spacers (2) of adjacent folds of a pleat, depending on their definition, meeting and/or not meeting in the pleat.

13. A nonwoven fabric (1), particularly a filter medium or air filter medium, comprising spacers (2) arranged in a manner such that said spacers (2) keep substantially flat layers of the nonwoven fabric (1) at a defined distance from one another, wherein the spacers (2) are formed in the primary forming method of the nonwoven fabric so that the nonwoven fabric has substantially the same material structure in the region of the spacers (2) as outside the region of the spacers (2).

14. The nonwoven fabric (1) according to claim 13, wherein the nonwoven fabric (1) is a single layer.

15. The nonwoven fabric (1) according to claim 13, wherein the filtering effect of the nonwoven fabric (1) remains substantially constant over its entire surface.

16. The nonwoven fabric according to claim 13, wherein the spacers (2) are arranged in groupings (4).

17. The nonwoven fabric according to claim 16, wherein the groupings (4) each comprise two spacers (2).

18. The nonwoven fabric according to claim 16, wherein the respective spacers of one grouping (4) are each arranged on a surface of the nonwoven fabric.

19. The nonwoven fabric according to claim 17, wherein the respective spacers of one grouping (4) are each arranged on one of the respective two surfaces of the nonwoven fabric.

20. The nonwoven fabric according to claim 17, wherein the respective spacers (2) of two adjacent groupings (4) are each arranged on a different one of the two surfaces of the nonwoven fabric.

21. The nonwoven fabric (1) according to claim 13 which can be pleated in self-supporting manner.

22. The nonwoven fabric (1) according to claim 13, wherein the structures are arranged in a defined manner such that substantially flat layers of the nonwoven fabric (1) can be kept apart from each other at a defined distance by the formed spacers (2), particularly by spacers (2) of adjacent folds of a pleat, depending on their definition, meeting and/or not meeting in the pleat.

23. The nonwoven fabric (1) according to claim 13, wherein the spacers (2) are arranged on the flat layers of the nonwoven fabric.

24. The nonwoven fabric (1) according to claim 13, wherein the height of the spacers (2) is contingent upon the position of the respective spacer (2) in a substantially flat layer of the pleated nonwoven fabric.

25. The nonwoven fabric (1) according to claim 24, wherein the height increases from a first pleat (A, X) to a second pleat (A, X) and particularly decreases again to a third pleat (A, X).

26. The nonwoven fabric (1) according to claim 13, wherein the height P of the spacers (2) is preferably from 0.1 to 2.0 cm, preferentially 0.2 to 1.0 cm, particularly preferentially 0.3 to 0.8 cm, particularly preferentially 0.4 to 0.6 cm, and most preferentially 0.5 cm.

27. (canceled)

28. A filter (1) comprising a nonwoven fabric in accordance with claim 13.

29. The filter (1) according to claim 28, wherein pleats (A, X) extend between groupings (4) of spacers (2).

30. The filter (1) according to claim 28, wherein spacers (2) in the groupings (4) are arranged substantially in the direction of and/or substantially diagonal to a pleat (A, X).
